(19) United States
(12) Patent Application Publication
(10) Pub. No.: US 2011/0193851 A1
(43) Pub. Date: Aug. 11, 2011

(54) Method of Driving an Electro-Phoretic Display and Related Display System

(76) Inventors: Wei-Hua LU, Taipei (TW); Chih-Kuei HU, Jubei (TW); Wei-Ting LIU, Hacienda Heights, CA (US)

(21) Appl. No.: 12/701,629

(22) Filed: Feb. 8, 2010

(51) Int. Cl. G09G 3/34; G06F 3/038

(52) U.S. Cl. 345/213; 345/107

(57) ABSTRACT

The present invention discloses a method of driving an electro-phoretic display. The electro-phoretic display includes a first display region and a second display region. The method includes: utilizing the first display region to display a first image; updating the first image by a first updating frequency; utilizing the second display region to display a second image; and updating the second image by a second updating frequency; wherein the first image represents a first information, the first information has a first property, and the first updating frequency is corresponding to the first property; the second image represents a second information, the second information has a second property, and the second updating frequency is corresponding to the second property; and the first updating frequency is different from the second updating frequency.

### BACKGROUND OF THE INVENTION

1. Field of the Invention

The present invention relates to an electro-phoretic display, and more particularly, to a method of driving an electro-phoretic display.

2. Description of the Prior Art

The electro-phoretic display has replaced the LCD display in many applications. For example, the electro-phoretic display has been used in e-books or electronic readers because the electro-phoretic display consumes lower power when the image remains still.

According to the characteristics of the electro-phoretic display, the electro-phoretic display consumes more power when the displayed image is being updated. As is known, the conventional electro-phoretic display, similar to the LCD display, always updates the entire image. In this way, if the image should be updated frequently, the power consumption is huge.

Therefore, how to reduce the power consumption of the electro-phoretic display becomes a new issue in the industry.

### SUMMARY OF THE INVENTION

It is therefore a primary objective of the claimed invention to provide a method of driving electro-phoretic displays to reduce the power consumption.

According to an objective of the present invention, a method of driving an electro-phoretic display is disclosed. The electro-phoretic display comprises a first display region and a second display region, and the method comprises: utilizing the first display region to display a first image; updating the first image by a first updating frequency; utilizing the second display region to display a second image; and updating the second image by a second updating frequency; wherein the first image represents a first information, the first information has a first property, and the first updating frequency is corresponding to the first property; the second image represents a second information, the second information has a second property, and the second updating frequency is corresponding to the second property; and the first updating frequency is different from the second updating frequency.

According to an objective of the present invention, a method of driving an electro-phoretic display is disclosed. The electro-phoretic display comprises a first display region and a second display region, and the method comprises: utilizing the first display region to display a first image corresponding to a first information; generating a first trigger according to an event of the first information; updating the first image according to the first trigger; utilizing the second display region to display a second image corresponding to a second information; generating a second trigger according to an event of the second information; and updating the second image according to the second trigger; wherein the first trigger and the second trigger are independent.

According to an objective of the present invention, a display system is disclosed. The display system comprises: an electro-phoretic display, comprising a first display region and a second display region, wherein the first display region is used for displaying a first image corresponding to a first information and the second display region is used for displaying a second image corresponding to a second information; at least one data driver, coupled to the electro-phoretic display; at least one selecting driver, coupled to the electro-phoretic display; and a timing controller, for controlling the data driver and the selecting driver to update the first image in the first display region and the second image in the second display region respectively according to a first updating frequency and a second updating frequency; wherein the first updating frequency and the second updating frequency are different.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of an electro-phoretic display according to a first embodiment of the present invention.

FIG. 2 is a diagram of an electro-phoretic display according to a second embodiment of the present invention.

FIG. 3 is a diagram of an electro-phoretic display according to a third embodiment of the present invention.

FIG. 4 depicts a flow chart showing an updating policy according to the first embodiment of the present invention.

FIG. 5 depicts a flow chart showing an updating policy according to the second embodiment of the present invention.

FIG. 6 depicts a flow chart showing an updating policy according to the third embodiment of the present invention.

FIG. 7 is a schematic diagram of an electro-phoretic display with timing controller and cascading data driver according to an embodiment of the present invention.

### DETAILED DESCRIPTION

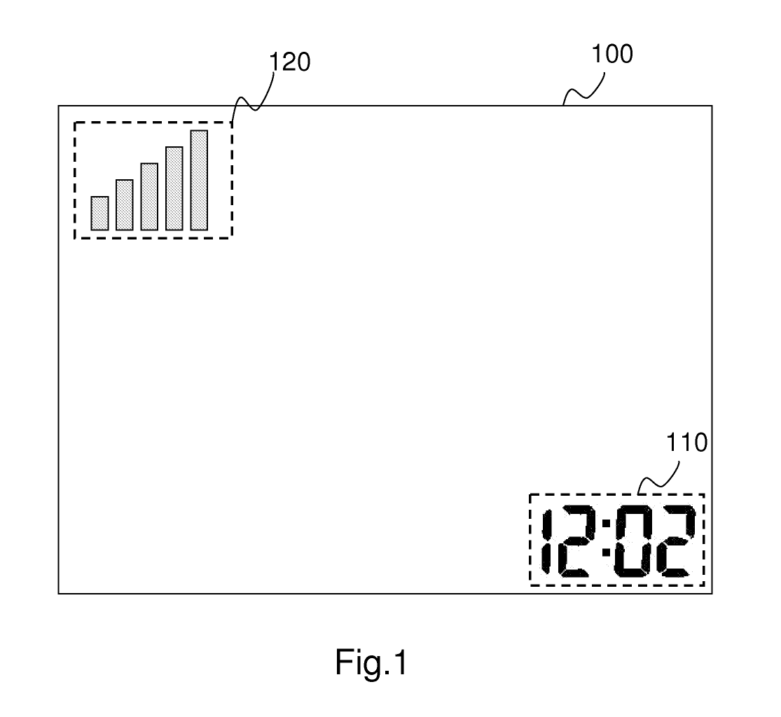

Please refer to FIG. 1, which is a diagram of an electro-phoretic display (EPD) 100 according to a first embodiment of the present invention. In this embodiment, we assume that the electro-phoretic display 100 is used in a cell phone. Please note, in the actual implementation, the electro-phoretic display 100 can be utilized in all kinds of electronic products, the cell phone here is regarded as an embodiment, not a limitation.

As shown in FIG. 1, the electro-phoretic display 100 comprises a first display region 110 and a second display region 120. In this embodiment, the first display region 110 is used for displaying a first image, and the second display region 120 is used for displaying a second image. Furthermore, in this embodiment, the first image represents a first information, for example but not limited to, a clock information, the second image represents a second information, for example but not limited to, a status information. As is shown, the clock information shows the current hour and minute, and the status information shows the communication quality.

In this embodiment, the electro-phoretic display 100 updates the first image (the first display region 110) and the second image (the second display region 120) according to different updating policies.

Please note, although in the above-mentioned embodiment, there are only two display regions, and the sizes of the display regions seems to be fixed, they are only regarded as an example, not a limitation of the present invention. In the actual implementation, the number of the display regions can be increased, and the size of each display regions can be changed.

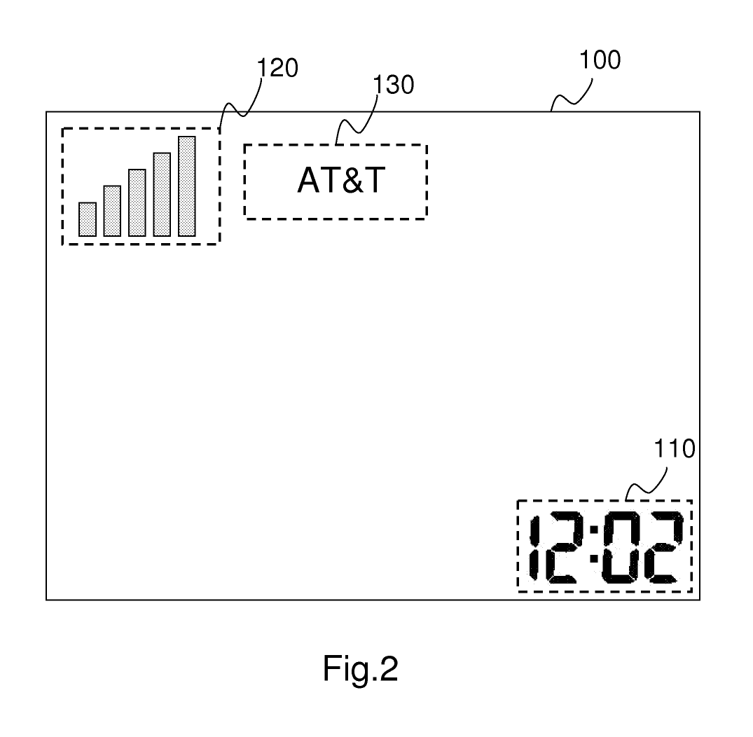

For example, please refer to FIG. 2, which is a diagram showing an EPD display 100 according to a second embodiment of the present invention. As shown in FIG. 2, the EPD display 100 comprises a first display region 110, a second display region 120, and a third display region 130. The first display region 110 and the second display region 120 are the same as those disclosed in the first embodiment and thus omitted here. Please note that, in this embodiment, the EPD display 100 further comprises the third display region 130. The third display region 130 can be utilized for display another image. In this embodiment, the display region 130 is used to display a third image, which represents a carrier information. As is shown, the third image shows the carrier provider (AT&T). Surely, the third image can represent any other information, and the above-mentioned communication carrier provider is only regarded as an embodiment, not a limitation.

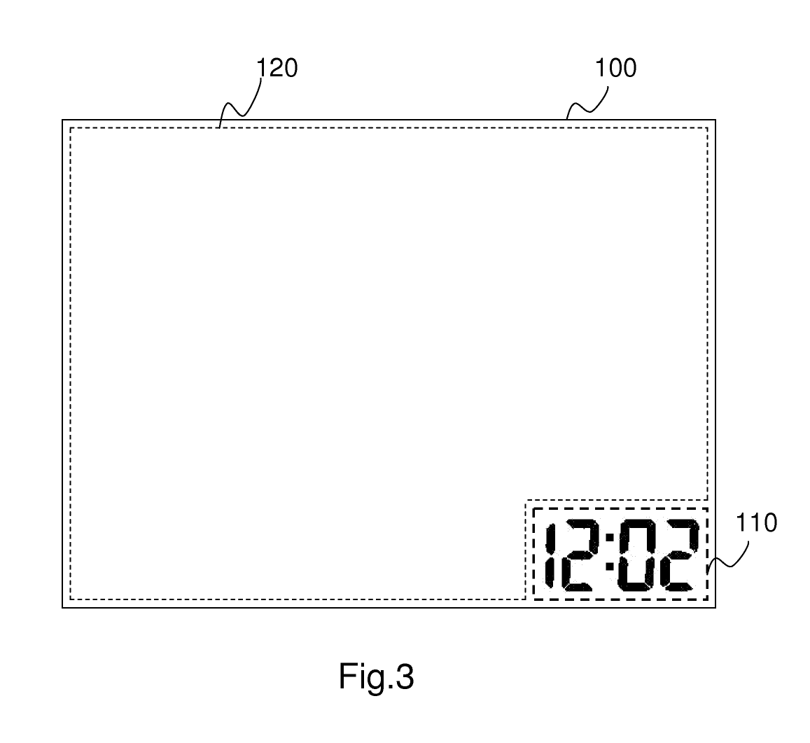

In addition, please refer to FIG. 3, which is a diagram showing an EPD display 100 according to a third embodiment of the present invention. As shown in FIG. 3, the EPD display 100 comprises a first display region 110 and a second display region 120. Please note, in this embodiment, the second display region 120 is larger than that shown in FIG. 1. For example, the second display region 120 can be defined as all the other display region other than the first display region 110 as shown in FIG. 3. In this way, the second display region 120 can be used for display various sizes of images.

Please note, the sizes of the display regions and the number of the display regions can be adjusted according to different design demands, and the images displayed in the display regions can represent any other information. These changes all obey the spirit of the present invention.

As mentioned previously, the images shown in display regions are updated according to different updating policies. For simplicity, in the following illustrations, the EPD display 100 comprising the first display region 110 and the second display region 120 shown in FIG. 1 is utilized for the following disclosure.

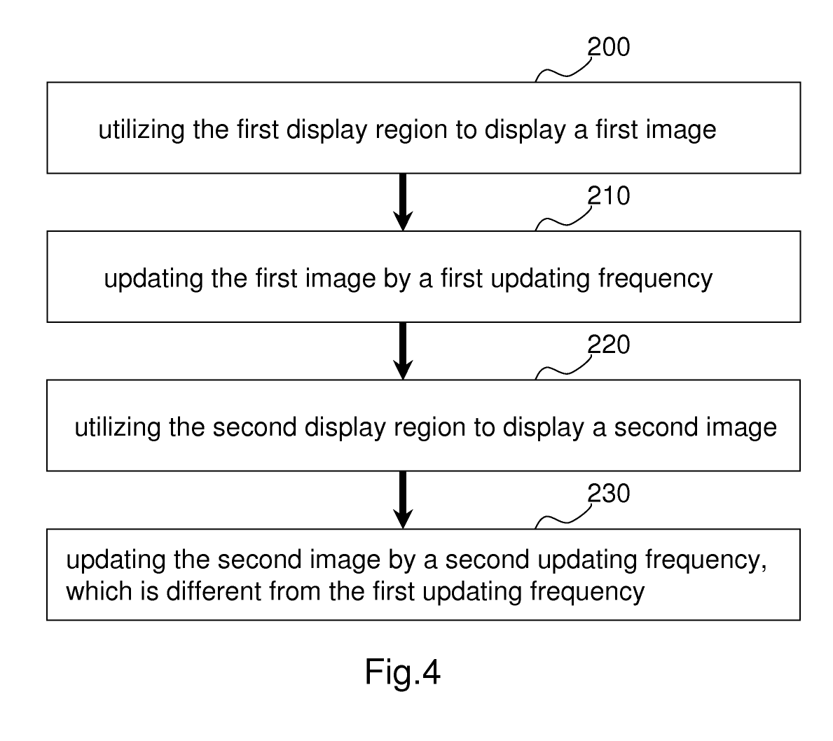

Please refer to FIG. 4, which depicts a flow chart showing an updating policy according to the first embodiment of the present invention. The flow chart comprises following steps:

Step 200: utilizing the first display region to display a first image;
Step 210: updating the first image by a first updating frequency;
Step 220: utilizing the second display region to display a second image;
Step 230: updating the second image by a second updating frequency, which is different from the first updating frequency.

In this embodiment, the present invention utilizes the first display region to display a first image (step 200). As mentioned previously, in this embodiment, the first image represents a first information (for example, clock information)

Please note, the present invention EPD display 100 updates the first image shown in the first display region 110 according to its property. Taking the clock information as an example, the clock information may have its own property, related to the updating requirement. For example, in a cell phone, the clock information may include hour information and minute information, and it means that the clock information should be updated at least once per minute.

Therefore, the present invention determines a first updating frequency according to the above-mentioned property. And then, the present invention utilizes the first updating frequency to update the first image shown in the first display region (step 210). For example, the present invention can determine the first updating frequency as once per minute, and update the first image once per minute.

Similarly, the present invention utilizes the second display region 120 to display a second image (step 220). As mentioned previously, in this embodiment, the second image represents a status information (for example, information showing the communication status). As mentioned previously, the status information has its own property, related to the updating requirement. For example, the communication status may need to be updated frequently such that the user can know the variance of the current communication quality immediately. Therefore, in this case, the present invention can determine the second updating frequency as once per 10 seconds, and update the second image shown in the second display region 120 once per 10 seconds (step 230).

From the above, it can be seen that the present invention utilizes different updating frequencies to update the first and second images respectively shown in the first display region 110 and the second display region 120. And the updating frequencies are determined according to the properties of the information to be displayed in the first display region 110 and the second display region 120.

The EPD display 100 consumes power when the first image and the second image are updated. In the above-mentioned mechanism, the present invention determines the updating frequency according to the information property. Therefore, if the information quality represents that the information does not need to refresh so frequently, the updating frequency of the information can be lower. Furthermore, the present invention utilizes different frequencies to refresh different information to optimize the power consumption of each display region. This can reduce more power consumption.

Please note, the first information and the second information can be previously determined. For example, the first display region 110 can be previously determined to display clock information and the second display region 120 can be previously determined to display communication quality information. This means that the present invention can previously determine the first updating frequency and the second updating frequency, too.

Please refer to FIG. 2 again, for the third display region 130, the third image displayed in the third display region 130 represents the carrier information. As is known, the carrier information is barely changed. Therefore, the present invention can define a third frequency, which is lower than the above-mentioned first and second frequencies (even equal to zero) to update the third image shown in the third display region 130. Obviously, this saves more power.

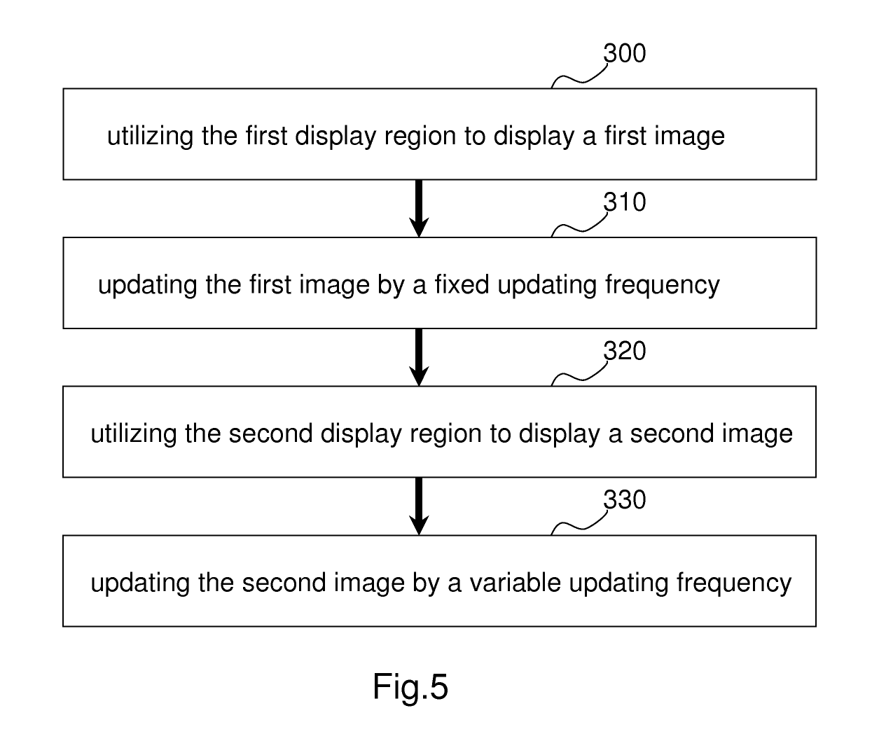

Please refer to FIG. 5, which depicts a flow chart showing an updating policy according to the second embodiment of the present invention. The flow chart comprises following steps:

Step 300: utilizing the first display region to display a first image;
Step 310: updating the first image by a first updating frequency, which is fixed;
   Step 320: utilizing the second display region to display a second image;
Step 330: updating the second image by a second updating frequency, which is variable.

In this embodiment, similarly, the present invention respectively utilizes the first display region 110 and the second display region 120 to display a first and a second images. (step 300 and step 320)

Please note, this embodiment is quite similar to the first embodiment. The difference between the first embodiment and the second embodiment is that in this embodiment, the first image of the first display region 110 is updated by a fixed updating frequency and the second image of the second display region 120 is updated by a variable updating frequency.

Taking the above-mentioned communication information as an example, the communication information is used for informing the communication quality to the user. Theoretically, when the user is in the same place, the communication quality is stable. On the other hand, when the user moves, the communication quality may vary. Therefore, according to the property, the present invention can utilize variable updating frequency to deal with this situation. For example, when the communication quality is stable, the present invention utilizes a lower frequency (for example, once per 10 seconds) to update the second image of the second display region 120, and if the communication quality starts to vary, the present invention utilizes a higher frequency (for example, once per second) to update the second image of the second display region 120 in order to refresh the communication quality immediately (step 330). Another example is that the variable updating frequency has higher updating frequency when the cell phone is in active mode, and the variable updating frequency has lower updating frequency when the cell phone is in standby mode.

For the fixed updating frequency utilized for updating the first image of the first display region 110, it is the same as the first embodiment, and thus omitted here. For example, the clock information can be updated once per minute. It is obvious that the present invention can utilize this fixed updating frequency to renew the clock information displayed in the first display region 110 (step 310).

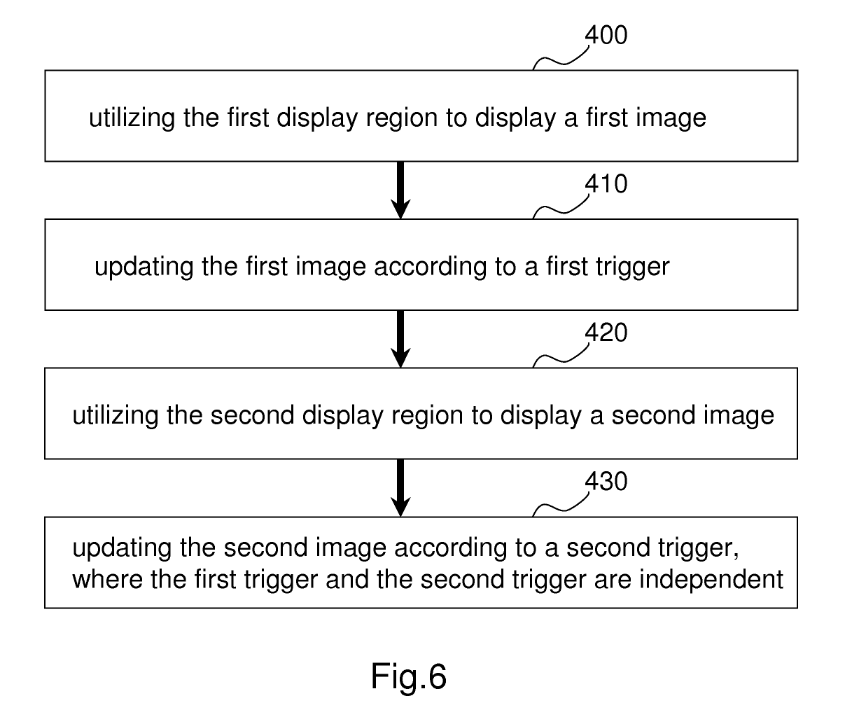

Please refer to FIG. 6, which depicts a flow chart showing an updating policy according to the second embodiment of the present invention. The flow chart comprises following steps:

Step 400: utilizing the first display region to display a first image;
Step 410: updating the first image according to a first trigger;
   Step 420: utilizing the second display region to display a second image;
   Step 430: updating the second image according to a second trigger, where the first trigger and the second trigger are independent.

In this embodiment, similarly, the present invention respectively utilizes the first display region 110 and the second display region 120 to display a first and a second images. (step 400 and step 420)

In this embodiment, the present invention provides an event-triggered mechanism to update the first and the second images. That is, the first image and the second images are updated by events instead of specific updating frequencies.

In this way, the EPD display 100 can be more power-saving, and can be updated more flexibly. In this embodiment, the present invention generates a trigger according to an event of the information. Taking the clock information as an example, the variance of the minute of the clock information can be regarded as an event, and the present invention generates a trigger according to the event. It means, each time when the minute changes, the present invention generates a trigger. In other words, the present invention generates the trigger once per minute, and the first image shown in the first display region 110 is updated once per minute according to the triggers (step 410).

Furthermore, it is similar to the communication information. The variance of the communication quality can be regarded as an event. Therefore, when the communication quality changes, the present invention generates a trigger. Similarly, the second image shown in the second display region 120 is updated according to the trigger (step 430). In this manner, the present invention can update the second image of the second display region 120 only when the communication quality changes. There is no power wasted for unnecessarily renewing the second image of the second display region 120 when the communication information remains stable. Therefore, the present invention EPD display 100 can have lower power consumption.

In addition, in this embodiment, because the first image and the second image respectively correspond to different information (the clock information and the communication information), the triggers for respectively updating the first image (the first display region 110) and the second image (the second display region 120) are independent.

Please note, the present invention does not limit the type of the event. For example, the event can be a touch of the user, a user command, or any other embedded instructions, and the present invention can generate a trigger according to these events in order to update the images.

For example, if the user can push a button in order to activate a specific function, the “button-pushing” is regarded as an event, and the present invention generates a trigger to update, for example, the second image shown in the second display region 120 such that a user interface figure related to the specific function is displayed. For example, the user interface figure is popped out according to the trigger in the second display region 120 (e.g. shown in FIG. 3), wherein the size of the interface figure is various according to the specific function.

Or, the event is an embedded instruction. For example, the user can define a reminding message in a predetermined time point. When the time is at the time point, the present invention generates a trigger to update the second image of the second region 120 to show the reminding messages. These changes all fall within the scope of the present invention.

Please note, although in the above-mentioned embodiments, the clock information and the status information are displayed in the first display region 110 and the second display region 120, the clock information and the status information are utilized as examples, not limitations of the present invention. In the actual implementation, the display regions 110 and 120 can be utilized for all kinds of information, such as battery status, function icon, system name, schedule, calendar and so on. These changes obey the spirit of the present invention.

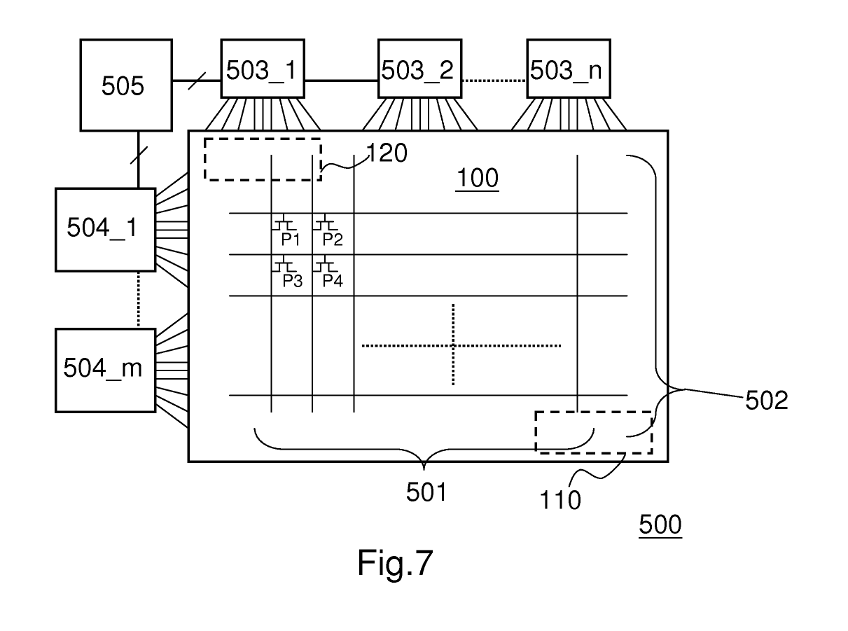

Please note, the above-mentioned embodiments are not hard for one having ordinary skills in the art to implement. Please refer to FIG. 7, which is a schematic diagram of an electro-phoretic display with timing controller and cascading data driver according to an embodiment of the present invention. The electro-phoretic display system 500 includes an EPD display 100, a plurality of column lines 501, a plurality of row lines 502, data drivers 503_1˜503_{—}n, selecting drivers 504_1˜504_{—}m, and a timing controller 505. The plurality of column lines 501 and the plurality of row lines 502 are perpendicular to each other, and the intersection between each column line and each row line form a pixel.

Please note, the EPD display 100 is the same as that shown in FIG. 1. The EPD display 100 comprises a first display region 110 and a second display region 120.

As mentioned previously, the present invention can update the images shown in the first display region 110 and the second display region 120 according to different updating policies. In this embodiment, the above-mentioned mechanism can be implemented by well-designing the timing controller 505.

As is known, the timing controller 505 can control the data drivers 503_1˜503_{—}n, selecting drivers 504_1˜504_{—}m to drive the EPD display 100. Therefore, if the timing controller 505 can correctly output the data to be displayed on the EPD display 100 to the data drivers 503_1˜503_{—}n and correctly turned on the pixels in the first display region 110 and the second display region 120 according to the above-mentioned frequencies (or triggers), the data can be displayed in the in the first display region 110 and the second display region 120 at the correct timings.

For example, when the first image shown in first display region 110 does not need to be updated, the timing controller 505 does not output any data to the data driver (e.g. data driver 503_{—}n) corresponding to the first display region 110. Or, the timing controller 505 can directly turn off the data driver 503_{—}n if the first image of the first display region 110 is not being updated. In this way, the first image of the first display region 110 is not updated at that time. On the other hand, if the first image of the first display region 110 needs to be updated, the timing controller 505 can output the data to be displayed to the corresponding data driver 503_{—}n, and turn on the corresponding selecting drivers (e.g. 504_{—}m) and the data driver 503_{—}n in order to turn on the pixels in the first display region 110 such that the data can be displayed in the first display region 110.

Similarly, when the second image shown in the second display region 120 is not being updated does not need to be updated, the timing controller 505 does not output any data to the data driver (e.g. data driver 503_1) corresponding to the second display region 120. Or, the timing controller 505 can directly turn off the data driver 503_1 if the second image shown in the second display region 120 is not being updated. In this way, the second image shown in the second display region 120 is not being updated at that time. On the other hand, if the second image shown in the second display region 120 needs to be updated, the timing controller 505 can output the data to be displayed to the corresponding data driver 503_1, and turn on the corresponding selecting drivers (e.g. 504_1) and the data driver 503_1 in order to turn on the pixels in the second display region 120 such that the data can be displayed in the second display region 120.

For small size panel application, there could be only one data driver 503 and one selecting driver 504. In this case, when the first display region 110 does not need to be updated, the timing controller 505 does not output any data to the data line K ˜ data line N of the data driver 503 corresponding to the first display region 110. Or, the timing controller 505 can directly turn off the buffers of the data line K ˜ data line N of the driver 503. In this way, the first display region 110 is not updated at that time. On the other hand, if the first display region 110 needs to be updated, the timing controller 505 can output the data to be displayed to the corresponding data line K ˜ data line N of the data driver 503, and turn on the corresponding selecting line J ˜ selecting line M of the selecting driver 504 in order to turn on the pixels in the first display region 110 such that the data can be displayed in the first display region 110. The mechanism of updating the second image of the second display region 120 is similar to the first display region 110, and the detail will be omitted herein.

As long as the above-mentioned operations are repeated according to the first and second frequencies (or triggers), the above-mentioned updating mechanism can be accomplished. Those skilled in the art should understand how to implement it according to the above disclosure, and further details are thus omitted herein.

In contrast to the prior art, the present invention can update the first region and the second region according to different updating policies. Therefore, the present invention EPD display can be utilized more flexibly and more power-saving.

Those skilled in the art will readily observe that numerous modifications and alterations of the device and method may be made while retaining the teachings of the invention.

What is claimed is:

1. A method of driving an electro-phoretic display, the electro-phoretic display comprising a first display region and a second display region, and the method comprising:
utilizing the first display region to display a first image;
updating the first image by a first updating frequency;
utilizing the second display region to display a second image; and
updating the second image by a second updating frequency;
wherein the first image represents a first information, the first information has a first property, and the first updating frequency is corresponding to the first property; the second image represents a second information, the second information has a second property, and the second updating frequency is corresponding to the second property; and the first updating frequency is different from the second updating frequency.

2. The method of claim 1, wherein the first image represents a clock information.

3. The method of claim 2, wherein the first updating frequency is once per minute.

4. The method of claim 1, wherein the second image represents a status information.

5. The method of claim 4, wherein the second updating frequency is once per 10 seconds.

6. The method of claim 1, wherein the second image represents a carrier information.

7. The method of claim 6, wherein the second updating frequency is substantially equal to 0.

8. The method of claim 1, wherein the first frequency is a fixed frequency, and the second frequency is a fixed frequency.

9. The method of claim 8, wherein the first frequency is a fixed frequency, and the second frequency is a variable frequency.

10. A method of driving an electro-phoretic display, the electro-phoretic display comprising a first display region and a second display region, and the method comprising:
utilizing the first display region to display a first image corresponding to a first information;
generating a first trigger according to an event of the first information;
updating the first image according to the first trigger;
utilizing the second display region to display a second image corresponding to a second information;
generating a second trigger according to an event of the second information; and
updating the second image according to the second trigger;
wherein the first trigger and the second trigger are independent.

11. The method of claim 10, wherein the event of the first information represents a variance of the first information.

12. The method of claim 11, wherein the first information is a clock information comprising hour information and minute information, and the variance of the first information is the variance of the minute information.

13. The method of claim 10, wherein the size of the second image is various.

14. The method of claim 10, wherein the event of the second information represents a variance of the second information.

15. The method of claim 10, wherein the event of the first information or the second information is capable of being a button-pushing, a user command, or an embedded instruction.

16. A display system comprising:
an electro-phoretic display, comprising a first display region and a second display region, wherein the first display region is used for displaying a first image corresponding to a first information and the second display region is used for displaying a second image corresponding to a second information;
at least one data driver, coupled to the electro-phoretic display;
at least one selecting driver, coupled to the electro-phoretic display; and
a timing controller, for controlling the data driver and the selecting driver to update the first image in the first display region and the second image in the second display region respectively according to a first updating frequency and a second updating frequency;
wherein the first updating frequency and the second updating frequency are different.

17. The display system of claim 16, wherein the first updating frequency is a fixed frequency, and the second updating frequency is a fixed frequency.

18. The display system of claim 16, wherein the first updating frequency is a fixed frequency, and the second updating frequency is a variable frequency.

19. The display system of claim 16, wherein the display system comprises a plurality of data drivers, and the timing controller turns off a data driver corresponding to the first display region if the first image is not being updated.

20. The display system of claim 16, wherein the display system comprises a plurality of data drivers, and the timing controller turns on a data driver corresponding to the first display region if the first image is being updated.
